(19) United States
(12) Patent Application Publication
(10) Pub. No.: US 2006/0215124 A1
(43) Pub. Date: Sep. 28, 2006

(54) Image projection apparatus for adjusting white balance in consideration of temperature and light level of LED and method thereof

(75) Inventor: Jeong-phil Seo, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/370,951

(22) Filed: Mar. 9, 2006

(30) Foreign Application Priority Data
Mar. 9, 2005 (KR) 2005-0019702

(51) Int. Cl. G03B 21/16

(52) U.S. Cl. 353/52

(57) ABSTRACT

An image projection apparatus adjusting a whit balance in consideration of temperatures and light levels of LEDs and a white balance adjustment method thereof. The image projection apparatus comprises a light source unit sequentially emitting lights generated by a red (R)-light emitting element, a green (G)-light emitting element, and a blue (B)-light emitting element. Light levels of the R-light emitting element, the G-light emitting element and the B-light emitting element change depending on changes in temperature. An image generation unit generates an image using the lights sequentially emitted from the light source unit and projects the image. A driving unit drives the light source unit and the image generation unit. A temperature sensor measures a temperature of the light source unit. A light sensor measures levels of light generated by the R-light emitting element, the G-light emitting element, and the B-light emitting element. A controller controls a driving operation of the driving unit based on the levels of light measured by the light sensor if the temperature of the light source unit measured by the temperature sensor exceeds a threshold, and adjusts a white balance of the image projected from the image generation unit. Accordingly, even if the temperatures of the LEDs increase due to a prolonged use of the image projection apparatus and thus light levels are deviated from a reference value, a white balance of a projected image is optimally adjusted. As a result, there is no image degradation and an optimal image can be provided to a user.

### CROSS-REFERENCE TO RELATED APPLICATIONS

This application claims benefit under 35 U.S.C. §119(a) of Korean Patent Application No. 2005-19702, filed on Mar. 9, 2005, the entire content of which is hereby incorporated by reference.

### BACKGROUND OF THE INVENTION

1. Field of the Invention

The present invention relates to an image projection apparatus and a white balance adjustment method thereof More particularly, the present invention relates to an image projection apparatus which uses a light emitting diode as a light source and a white balance adjustment method thereof.

2. Description of the Related Art

An image projection apparatus receives an image signal, forms an image corresponding to the image signal, and projects the image on a screen. Such an image projection apparatus is called a “projector.” The image projection apparatus typically adopts the following image forming process. White light emitted from a white lamp passes through a color wheel. The color wheel filters the white light into red (R)-light, green (G)-light and blue (B)-light in sequence. The R, G, and B-lights are modulated into a corresponding image by a digital micromirror device (DMD).

However, the white lamp has disadvantages of large bulk and high power consumption. Therefore, if the image projection apparatus uses the white lamp as a light source, the volume of the image projection apparatus becomes increased and power consumption is increased. This is more problematic if the white lamp is used as a light source in a portable image projection apparatus carrying with a battery for power supply.

In order to solve this problem, an image projection apparatus using three color (red, green, blue) light emitting diodes (LEDs) as a light source has been suggested.

However, when the LEDs are driven for a long time, temperatures of the LEDs increase, which causes a reduction in levels of lights emitted from the LEDs. The degree of reduction of light level caused by the increase of temperature differs depending on the kind of LEDs and manufacturers of the LEDs. Accordingly, when the image projection apparatus using the LEDs as a light source is in use for a long time, deviations with respect to the levels of light from the LEDs become unacceptable. As a result, deviations with respect to amounts of R-light, G-light, and B-light become unacceptable.

The unacceptable deviations of the light amounts cause a image degradation of the image provided to a user, and also require a white balance to be adjusted.

### SUMMARY OF THE INVENTION

The present invention has been developed in order to solve the problems described above and to provide additional advantages which will become apparent from the following description. Accordingly, an aspect of embodiments of the present invention is to provide an image projection apparatus which adjusts a white balance in consideration of a temperature and a light level of a light source to prevent an image degradation, and a white balance adjustment method thereof.

To achieve the above aspect, an image projection apparatus comprises a light source unit for sequentially emitting lights generated by a red (R)-light emitting element, a green (G)-light emitting element, and a blue (B)-light emitting element. Light levels of the R-light emitting element, the G-light emitting element and the B-light emitting element change depending on changes in temperature. An image generation unit generates an image using the lights sequentially emitted from the light source unit and projects the image. A driving unit drives the light source unit and the image generation unit. A temperature sensor measures a temperature of the light source unit. A light sensor measures levels of lights generated by the R-light emitting element, the G-light emitting element, and the B-light emitting element. A controller controls a driving operation of the driving unit based on the levels of light measured by the light sensor if the temperature of the light source unit measured by the temperature sensor exceeds a threshold, and adjusts a white balance of the image projected from the image generation unit.

Preferably, but not necessarily, the temperature sensor is provided around at least one of the R-light emitting element, the G-light emitting element, and the B-light emitting element to measure a temperature of the at least one light emitting element.

Preferably, but not necessarily, the temperature sensor is provided on a panel to which at least one of the R-light emitting element, the G-light emitting element, and the B-light emitting element is attached.

Preferably, but not necessarily, the image projection apparatus further comprises a heating unit for discharging heat generated from at least one of the R-light emitting element, the G-light emitting element and the B-light emitting element. The temperature sensor is provided on at least one of the heating unit and a surrounding portion of the heating unit to measure the temperature of the light source unit.

Preferably, but not necessarily, the light sensor uses lights sequentially emitted from the image generation unit and thereby measures light levels of the R-light emitting element, the G-light emitting element, and the B-light emitting element.

Preferably, but not necessarily, the driving unit comprises a light source driving unit for generating and supplying driving pulses for the respective R-light emitting element, G-light emitting element, and B-light emitting element of the light source unit, thereby driving the light source unit. The controller determines levels of the driving pulses for the respective R-light emitting element, G-light emitting element, and B-light emitting element based on the level of light measured by the light sensor, and controls the light source driving unit to generate the driving pulses according to the determined pulse levels.

Preferably, but not necessarily, the driving unit comprises a light source driving unit for generating and supplying driving pulses for the respective R-light emitting element, G-light emitting elements, and B-light emitting element, thereby driving the light source unit. The controller determines pulse-widths and starting times of driving pulses for the respective R-light emitting element, G-light emitting element and B-light emitting element based on the levels of light measured by the light sensor, and controls the light source driving unit to generate the driving pulses according to the determined pulse-widths and starting times.

Preferably, but not necessarily, the driving unit comprises an image generation driving unit for generating reflection angle adjustment signals to adjust reflection angles for the lights sequentially entering the image generation unit from the light source unit for each pixel, and supplying the reflection angle adjustment signals to the image generation unit such that the image generation unit generates and projects the image. The controller determines levels of the reflection angle adjustment signals based on the levels of lights measured by the light sensor and controls the image generation driving unit to generate reflection angle adjustment signals according to the determined levels of reflection angle adjustment signals.

According to an exemplary embodiment of the present invention, a method of adjusting a white balance of an image projection apparatus is provided. The image projection apparatus comprises a light source unit for sequentially emitting lights generated by light emitting elements, light levels of the light emitting elements changing depending on changes in temperature. An image generation unit generates an image using the lights sequentially emitted from the light source unit and projects the image. The method comprises a) measuring a temperature of the light source unit ; b) if the measured temperature of the light source unit exceeds a threshold, measuring levels of lights generated by the light emitting elements ; and c) controlling a driving operation of one of the light source unit and the image generation unit based on the measured light levels and thereby adjusting a white balance of the image projected from the image generation unit.

Preferably, but not necessarily, step a) uses a temperature sensor provided around at least one of the light emitting elements to measure a temperature of the light emitting element located around the temperature sensor.

Preferably, but not necessarily, step a) uses the temperature sensor provided on a panel to which at least one of the light emitting elements is attached and measures a temperature of the light emitting element located around the temperature sensor.

Preferably, but not necessarily, step a) uses a temperature sensor provided on one of a heating unit and a surrounding portion of the heating unit to measure a temperature of the light source unit, the heating unit discharging heats generated from at least one of the light emitting elements.

Preferably, but not necessarily, step b) uses lights sequentially emitted from the image generation unit and thereby measures light levels of the light emitting elements.

Preferably, but not necessarily, step c) comprises determining levels of driving pulses for the respective light emitting elements based on the measure light levels; and supplying the driving pulses according to the determined pulse levels to the light source unit and driving the light source unit such that a white balance of the image projected from the image generation unit is adjusted.

Preferably, but not necessarily, step c) comprises determining pulse-widths and starting times of driving pulses for the respective light emitting elements based on the measured light levels; and supplying the driving pulses according to the determined pulse-widths and starting times to the light source unit and driving the light source unit such that a white balance of the image projected from the image generation unit is adjusted.

Preferably, but not necessarily, step c) comprises determining levels of reflection angle adjustment signals based on the measured light levels, the reflection angle adjustment signals to adjust reflection angles for the lights sequentially emitted from the light source unit to the image generation unit for each pixel; and supplying the reflection angle adjustment signals according to the determined signal levels to the image generation unit in order for the image generation unit to generate and project the image, such that a white balance of the image projected from the image generation unit is adjusted.

According to an exemplary embodiment of the present invention, an image projection apparatus comprises a light source unit for sequentially emitting lights generated by light emitting elements. Light levels of the light emitting elements change depending on changes in temperature. An image generation unit generates an image using the lights sequentially emitted from the light source unit and projects the image. A driving unit drives the light source unit and the image generation unit. A temperature sensor measures a temperature of the light source unit. A light sensor measures levels of lights generated by the light emitting elements. A controller controls a driving operation of the driving unit based on the levels of light measured by the light sensor if the temperature of the light source unit measured by the temperature sensor exceeds a threshold, and adjusts a white balance of the image projected from the image generation unit.

The light emitting elements may comprise a light emitting diode (LED).

### BRIEF DESCRIPTION OF THE DRAWINGS

The above aspects and other advantages of exemplary embodiments of the present invention will be more apparent from the following description thereof, with reference to the accompanying drawings, in which:

FIG. 1 is a block diagram showing an image projection apparatus which adjusts a white balance in consideration of a temperature and a light level of a light emitting diode (LED) according to an exemplary embodiment of the present invention;

FIG. 2A is a flowchart showing a method of adjusting a white balance in consideration of a temperature and a light level of a LED according to an exemplary embodiment of the present invention;

FIG. 2B is a flowchart showing a method of adjusting a white balance in consideration of a temperature and a light level of a LED according to another exemplary embodiment of the present invention;

FIG. 2C is a flowchart showing a method of adjusting a white balance in consideration of a temperature and a light level of a LED according to still another exemplary embodiment of the present invention;

FIGS. 3A to 3C are views showing waveforms of LED driving pulses;

FIG. 4 is a view showing a light source unit embodied by a temperature sensor;

FIG. 5A is a view showing a light source unit embodied by one heating unit and one temperature sensor;

FIG. 5B is a view showing a light source unit embodied by two heating units and two temperature sensors; and

FIG. 6 is a light source unit embodied by a plurality of LEDs.

Throughout the drawings, like reference numbers will be understood to refer to like elements features and structures.

### DETAILED DESCRIPTION OF EXEMPLARY EMBODIMENTS

Hereinbelow, exemplary embodiments of the present invention will be described in greater detail with reference to the accompanying drawings.

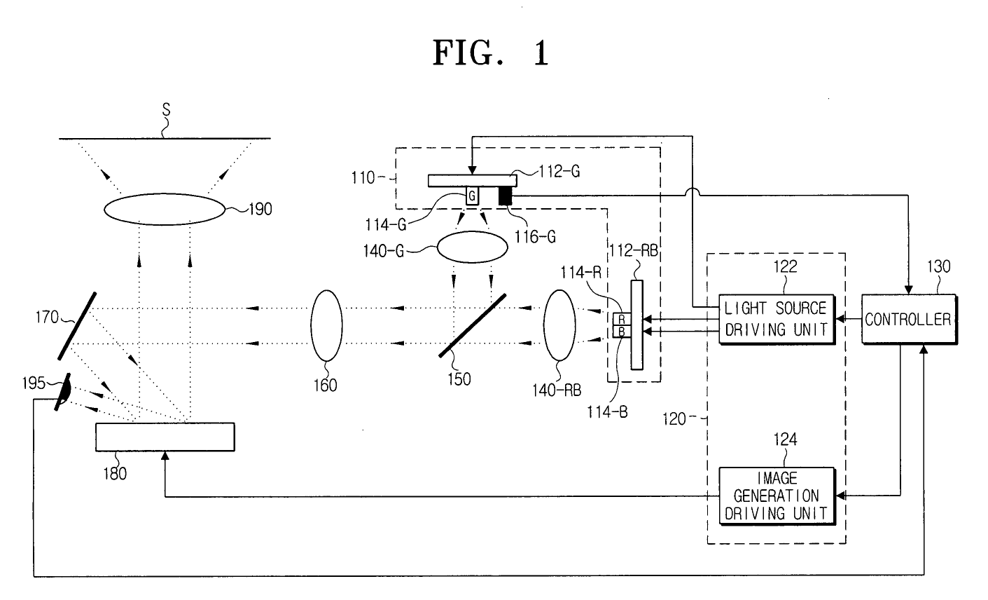

FIG. 1 is a block diagram showing an image projection apparatus according to an exemplary embodiment of the present invention. The image projection apparatus uses three-color light emitting diodes (LEDs), such as, red (R)-LED, green (G)-LED, and blue (B)-LED as a light source. The image projection apparatus takes temperatures and light levels of the LEDs into account in adjusting a white balance with respect to a projected image. In FIG. 1, solid-lines indicate paths for electrical signals such as driving signals and control signals, and dotted-lines indicate paths for light.

Referring to FIG. 1, the image projection apparatus comprises a light source unit 110, a driving unit 120, a controller 130, a red-blue collimating lens (RB-CL) 140-RB, a green collimating lens (G-CL) 140-G, a light filter 150, a relay lens 160, a reflection mirror 170, an image generation unit 180, a projection lens 190, and a light sensor 195.

The light source unit 110 generates and emits red-light, green-light, and blue-light in sequence. If the image projection apparatus is driven according to the national television system committee (NTSC) scheme, the light source unit 110 emits the R-light for the first 1/180 of a second (⅓ of a frame period), emits the G-light for the second 1/180 of a second, emits the B-light for the third 1/180 of a second, and then again emits the R-light for 1/180 of a second. If the image projection apparatus is driven according to the phase alternation by line (PAL) scheme, the light source unit 110 emits the R-light, the G-light and the B-light in sequence in every 1/150 of a second.

The light source unit 110 comprises a RB-panel 112-RB, a R-LED 114-R, a B-LED 114-B, a G-panel 112-G, a G-LED 114-G, and a G-temperature sensor 116-G.

The R-LED 114-R and the B-LED 114-B are attached to the RB-panel 112-RB, and they generate and emit R-light and B-light, respectively. The R-LED 114-R and the B-LED 114-B are respectively driven by a R-driving pulse and a B-driving pulse which are generated by a light source driving unit 122 (will be described below) and transmitted through a connector (not shown) provided in the RB-panel 112-RB.

The G-LED 114-G is attached to the G-panel 112-G, and it generates and emits G-light. The G-LED 114-G is driven by a G-driving pulse which is generated by the light source driving unit 122 and transmitted through a connector (not shown) provided in the G-panel 112-G.

The G-temperature sensor 116-G measures a temperature of the light source unit 110, and transmits the measurement result to the controller 130, which will be described later. The G-temperature sensor 116-G is located around the G-LED 114-G on the G-panel 112-G to measure a temperature of the G-LED 114-G.

In this embodiment, there is no temperature sensor to measure temperatures of the R-LED 114-R and the B-LED 114-B. This is because the LEDs of the light source unit 110 are sequentially driven for the same time and thus the LEDs have similar level of temperatures. That is, since there is no problem if the temperatures of the R-LED 114-R and the B-LED 114-B are set to the temperature of the G-LED 114-G measured by the G-temperature sensor 116-G, no temperature sensor is provided to measure the temperatures of the R-LED 114-R and the B-LED 114-B.

The R-light or the B-light emitted from the R-LED 114-R or the B-LED 114-B is concentrated by the RB-CL 140-RB and pass through the light filter 150. Then, the R or B light is incident on the image generation unit 180 through the relay lens 160 and the reflection mirror 170.

The G-light emitted from the G-LED 114-G is concentrated by the G-CL 140-G and reflected by the light filter 150. Then, the G-light is incident on the image generated unit 180 through the relay lens 160 and the reflection mirror 170.

The image generation unit 180 is driven by an image generation driving unit 124, which will be described below. The image generation unit 180 modulates the sequentially entering R-light, B-light, and G-light to generate an image. The image generation unit 180 projects the image on a screen. That is, the image generation unit 180 adjusts reflection angles with respect to the sequentially entering R-light, B-light, and G-light for each pixel to generate an image. The image generation unit 180 can be embodied by a digital micromirror device (DMD).

The image is projected from the image generation unit 180 on a screen S through the projection lens 190.

The driving unit 120 drives the light source unit 110 and the image generation unit 180 and comprises the light source driving unit 122 and the image generation driving unit 124.

The light source driving unit 122 generates the R-driving pulse, the G-driving pulse and the B-driving pulse to drive the R-LED 114-R, the G-LED 114-G and the B-LED 114-B, respectively, and supplies the generated driving pulses to the corresponding LEDs, thereby driving the LEDs in sequence.

The image generation driving unit 124 generates reflection angle adjustment signals to adjust the reflection angles with respect to the lights sequentially entering to the image generated unit 180 for each pixel, and supplies the generated reflection angle adjustment signals to the image generation unit 180 such that the image generation unit 180 generates and projects an image.

The light sensor 195 measures magnitudes of the R-light, the G-light, and the B-light sequentially emitted from the light source unit 110, and transmits the measurement results to the controller 130. That is, the light sensor 195 measures light levels of the R-LED 114-R, the G-LED 114-G, and the B-LED 114-B.

The controller 130 controls the light source driving unit 122 and the image generation driving unit 124 to adjust a white balance of the image projected from the image generation unit 180. The controller 130 takes the temperature measured by the G-temperature sensor 116-G and the light levels measured by the light sensor 195 into account to more appropriately adjust the white balance.

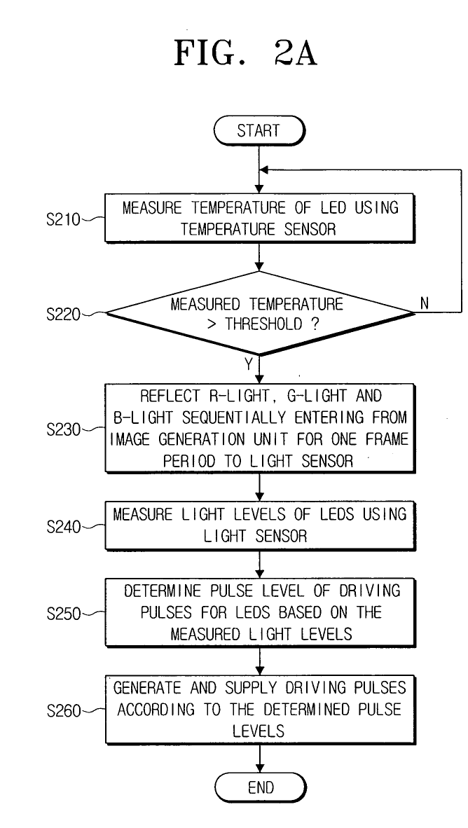

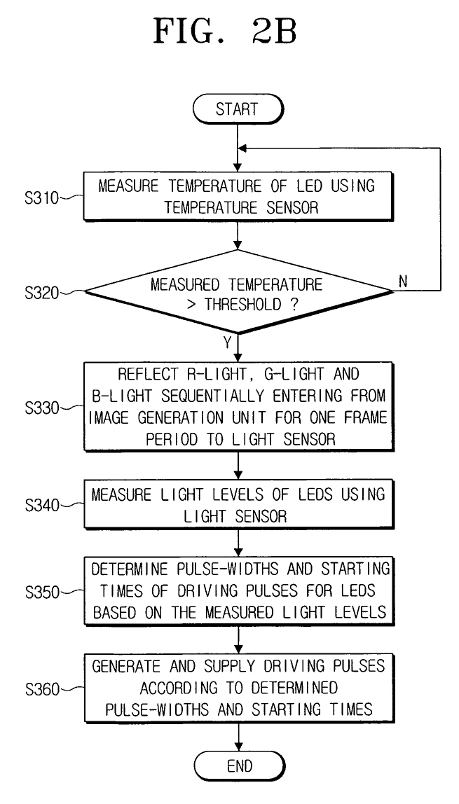

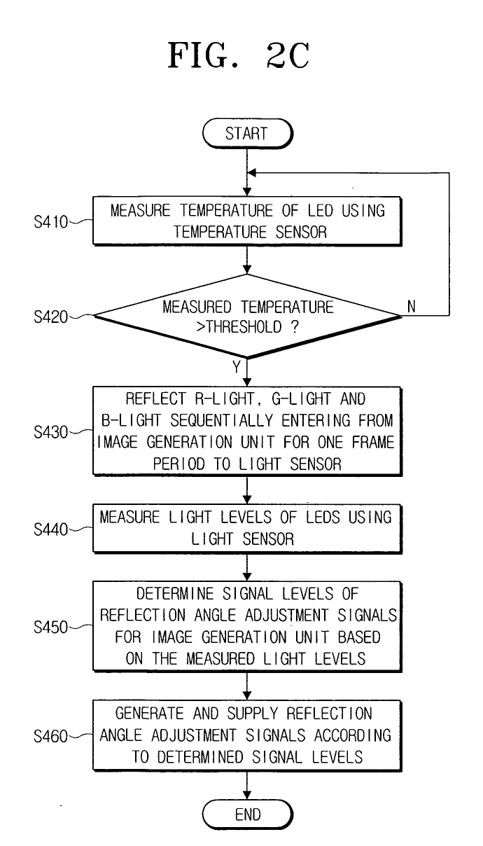

Hereinbelow, a white balance adjustment method of an image projection apparatus according to an exemplary embodiment of the present invention will be described with reference to FIG. 2A. FIG. 2A is a flowchart showing a method of adjusting a white balance in consideration of temperatures and light levels of LEDs according to an exemplary embodiment of the present invention.

Referring to FIG. 2A, temperatures of the LEDs are measured by a temperature sensor at step S210. More specifically, a temperature of the G-LED 114-G is measured by the G-temperature sensor 116-G. As described above, the temperatures of the R-LED 114-R and B-LED 114-B are assumed to be the same as that of the G-LED 114-G measured at step S210.

The light levels change according to the change in the temperatures of the LEDs. As the temperature increases, the light level decreases. The decrease rate of the light levels differs depending on the kinds of LEDs. More specifically, the light level of the R-LED 114-R (referred to as “R-light level” hereinbelow) has the highest decrease rate and the light level of the B-LED 114-B (referred to as “B-light level” hereinbelow) has the lowest decrease rate. That is, if the temperature increases, the R-light has the highest decrease in the light level and the B-light has the lowest decrease in the light level.

The image projection apparatus is designed to have 100% of R-light level, G-light level and B-light level at the beginning of driving. If the image projection apparatus is driven for a predetermined time and thus the temperatures of the LEDs increase, the R-light level, the G-light level and the B-light level decrease below 100% of level.

At this time, if the degree of increase of the temperature is relatively small, the deviations of the R-light level, the G-light level and the B-light level are tolerable. However, if the degree of increase of the temperature is relatively large, the deviation of the R-light level, the G-light level and the B-light level are intolerable. This requires a white balance of a image to be adjusted.

In order to prevent this problem in advance, the controller 130 determines whether the measured temperature exceeds a predetermined threshold at step S220. When the temperature reaches the threshold, the R-light level, the G-light level, the B-light level have intolerable deviations. That is, if the measured temperature exceeds the threshold, the increase of temperatures of LEDs is high and the R-light level, the G-light level and the B-light level are determined to have intolerable deviations. As a result, a white balance of the image is incorrectly set.

If the measured temperature exceeds the threshold at step S220, the controller 130 controls the image generation driving unit 124 such that the R-light, the B-light and the G-light are sequentially reflected from the image generation unit 180 to the light sensor 195 for one frame period at step S230. Then, the light sensor 195 sequentially measures the magnitudes of the R-light, the G-light, and the B-light, thereby measuring the R-light level, the G-light level and the B-light level at step S240. The light sensor 195 transmits the measurement results to the controller 130.

Then, the controller 130 determines levels of driving pulses for the respective LEDs based on the measured light levels at step S250. That is, the controller 130 determines a level of R-light driving pulse (referred to as “R-driving pulse level” hereinbelow), a level of G-light driving pulse (referred to as “G-driving pulse level” hereinbelow) and a level of B-light driving pulse (referred to as “B-driving pulse level”) based on the measured light levels.

More specifically, if a certain light level decreases below a reference light level (100%), the controller determines a R-driving pulse level, a G-driving pulse level and a B-driving pulse level to increase the certain light level to 100%. That is, a highest increase of driving pulse level is determined for an LED having a highest decrease of light level, and a least increase of driving pulse level is determined for an LED having a lowest decrease of light level.

If the determination of the driving pulse levels is complete, the light source driving unit 122 generates driving pulses according to the determined driving pulse levels and supplies the driving pulses to corresponding LEDs at step S260.

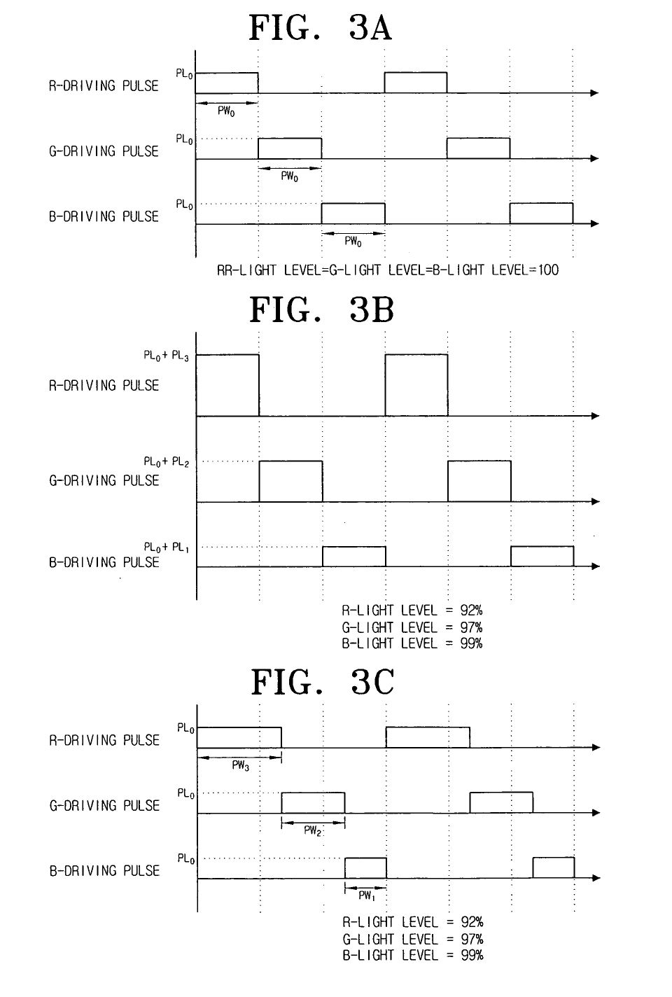

FIG. 3A shows a R-driving pulse, a G-driving pulse and a B-driving pulse generated by the light source driving unit 122 at the beginning of driving operation with 100% of R-light level, G-light level and B-light level, respectively. FIG. 3B shows a R-driving pulse, a G-driving pulse and a B-driving pulse generated by the light source driving unit 122 after a predetermined driving operation with 92% of R-light level, 97% of G-light level and 99% of B-light level. As shown in FIG. 3A, since 100% of R-light level, G-light level and B-light level are provided, all of the R-driving pulse, the G-driving pulse and the B-driving pulse have the same reference pulse level PLO.

On the other hand, as shown in FIG. 3B, since the R-light has the highest decrease of light level from 100% to 92%, the R-driving pulse has the highest increase of pulse level from PL₀ to PL₀+PL₃. Since the B-light has the least decrease of light level from 100% to 99%, the B-driving pulse has the least increase of pulse level from PL₀ to PL₀+PL₁. Accordingly, PL₃>PL₂>PL₁.

If the R-light level, the G-light level, and the B-light level decrease from 100% to 92%, 97%, 99%, respectively, the LEDs are driven with the driving pulses as shown in FIG. 3B, thereby having 100% of the R-light level, the G-light level and the B-light level. As a result, R-light, G-light, and B-light incident on the image generation unit 180 have the same light amount such that the white balance of an image generated and projected from the image generation unit 180 can be adjusted.

Hereinafter, a white balance adjustment method of an image projection apparatus according to another embodiment of the present invention will be described with reference to FIG. 2B. FIG. 2B is a flowchart showing a method of adjusting a white balance in consideration of temperatures and light levels of LEDs according to another exemplary embodiment of the present invention.

Because the steps S310 to S340 of FIG. 2B are essentially the same as the steps S210 to S240 of FIG. 2A, their descriptions will be omitted.

Referring to FIG. 2B, at step S350, the controller 130 determines pulse-widths and starting times of driving pulses for the respective LEDs based on the light levels measured at step S340. More specifically, the controller 130 determines a pulse-width and a starting time of a R-driving pulse based on the measured R-light level, determines a pulse-width and a starting time of a G-driving pulse based on the measured G-light level, and determines a pulse-width and a starting time of a B-driving pulse based on the measured B-light level.

If a certain LED has the highest decrease in the light level, a longest pulse width is determined for the driving pulse of the certain LED. If a certain LED has the least decrease in the light level, a shortest pulse-width is determined for the driving pulse of the certain LED.

The starting times of the respective driving pulses are determined such that driving pulses having different pulse-widths preferably do not overlap with one another temporally.

If the determination of the pulse-width and the starting timing is complete, the light source driving unit 122 generates driving pulses according to the determined pulse-widths and starting times, and supplies them to corresponding LEDs at step S360.

FIG. 3A shows a R-driving pulse, a G-driving pulse, and a B-driving pulse generated by the light source driving unit 122 at the beginning of driving operation with 100% of R-light level, G-light level and B-light level, respectively. FIG. 3C shows a R-driving pulse, a G-driving pulse and a B-driving pulse generated by the light source driving unit 122 after a predetermine driving operation with 92% of R-light level, 97% of G-light level, and 99% of B-light level. In the case of FIG. 3A, since 100% of R-light level, G-light level and B-light level are provided, all of the R-driving pulse, the G-driving pulse and the B-driving pulse have the same reference pulse-width PW₀.

On the other hand, in the case of FIG. 3C, since the R-light level is less than the G-light level and the G-light level is less than the B-light level (92%<97%<99%), the R-driving pulse-width is broader than the G-driving pulse-width and the G-driving pulse width is broader than B-driving pulse-width (PW₃>PW₂>PW₁). Also, starting times of the respective driving pulses change such that the R-driving pulse, the G-driving pulse and the B-driving pulse having different pulse widths do not overlap with one another temporally.

In the case of 92% of R-light level, 97% of G-light level and 99% of B-light level, when the LEDs are driven with the driving pulses as shown in FIG. 3C, a light-emitting time of the R-LED 114-4 having a relatively lower light level is prolonged, while a light-emitting time of the B-LED 114-B having a relatively higher light level is shortened. As a result, the R-light, the G-light, and the B-light incident on the image generation unit 180 have the same light amount such that a white balance of an image generated and projected from the image generation unit 180 can be adjusted.

Hereinafter, a white balance adjustment method of an image projection apparatus according to still another exemplary embodiment of the present invention will now be described with reference to FIG. 2C. FIG. 2C is a flowchart showing a method of adjusting a white balance in consideration of temperatures and light levels of LEDs according to still another embodiment.

Because the steps S410 to S440 of FIG. 2C are the same as the steps S210 to S240 of FIG. 2A, their descriptions will be omitted.

Referring to FIG. 2C, at step S450, the controller 130 determines levels of reflection angle adjustment signals based on the light levels measured at step S440. The reflection angle adjustment signal is to adjust reflection angles of light (R-light, G-light, and B-light) sequentially entering the image generation unit 180 for each pixel. More specifically, at step S450, the controller 130 determines a R-reflection angle adjustment signal level, a G-reflection angle adjustment signal level, and a B-reflection angle adjustment signal level based on the measured light levels, respectively.

The highest increase of reflection angle adjustment signal level is determined for a LED having the highest decrease of light level, such that the light projected from the image generation unit 180 to the project lens 190 have the highest increase in the light level. On the other hand, the least increase of reflection angle adjustment signal level is determined for a LED having the least decrease of light level, such that the light projected from the image generation unit 180 to the projection lens 190 has the lowest increase in the light level.

In the case of 92% of R-light level, 97% of G-light level and 99% of B-light level, the R-reflection angle adjustment signal has the highest increase in the signal level, and thus, the R-light projected from the image generation unit 180 to the projection lens 190 has the highest increase in the light amount. On the other hand, the B-reflection angle adjustment signal has the lowest increase in the signal level, and thus, the B-light projected from the image generation unit 180 to the projection lens 190 has the lowest decrease in the light amount.

If the determination of reflection angle adjustment signal levels is complete, the image generation driving unit 124 generates reflection angle adjustment signals according to the determined signal levels, and supplies the same to the image generation unit 180 at step S460.

If the image generation unit 180 is driven with the reflection angle adjustment signals generated at step S460, a light projected to the projection lens 190 with respect to the light having the highest decrease of light level has the highest increase in the light amount, whereas a light projected to the projection lens 190 with respect to the light having the least decrease of light level has the least increase in the light amount. As a result, a white balance of an image generated and projected from the image generation unit 180 is adjusted.

As described above, if the temperature of the G-LED 114-G measured by the G-temperature sensor 116-G exceeds the threshold, a white balance is adjusted in consideration of the light levels of the LEDs measured by the light sensor 195.

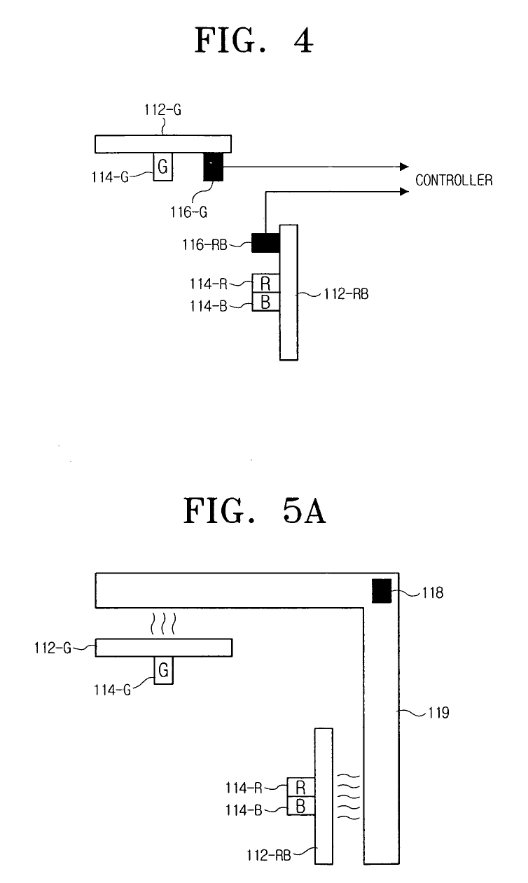

There is no limitation to the number of temperature sensors provided in the image projection apparatus. As show in FIG. 4, a RB-temperature sensor 116-RB is provided on the RB-panel 112-RB to measure temperatures of the R-LED 114-R and the B-LED 114-B.

If there is two temperature sensors in the image projection apparatus as shown in FIG. 4, a G-driving pulse level, a G-driving pulse width or a G-reflection angle adjustment signal level is determined based on the result of measurement of the G-temperature sensor 116-G, and a R-driving pulse level and a B-driving pulse level, a R-driving pulse width and a B-driving pulse width, or a R-reflection angle adjustment signal level and a B-reflection angle adjustment signal level are determined based on the result of measurement of the RB-temperature sensor 116-RB.

There is no limitation to the location of the temperature sensor provided in the image projection apparatus. That is, the temperature sensor is not necessarily provided on the RB-panel 112-RB or the C-panel 112-G.

For example, as shown in FIG. 5A, a temperature sensor 118 is provided on a heating unit 119 for discharging heats generated from the R-LED 114-R, the B-LED 114-B, and the C-LED 114-G to the outside. Alternatively, a temperature sensor 118 is provided around a heating unit 119.

Since the heating unit 119 is preferably embodied by a material of high thermal conductivity, the heating unit 119 has the substantially same temperature if it is located in any position. Therefore, the location of the temperature sensor 118 on the heating unit is not important. That is, the temperature sensor 118 can be located in any position of the heating unit 119, that is, on the heating unit 119 or around the heating unit 119.

If the image projection apparatus has two heating units 119-RB, 119-G, temperature sensors 118-RB, 118-G are provided on the respective heating units 119-RB, 119-G. If the heating unit 119-RB, 119G have similar temperatures, one of the two temperature sensors 118-RB, 118-G is provided and thus, the number of temperature sensors can be reduced.

There is no limitation to the location of the light sensor 195 provided in the image projection apparatus. The light sensor 195 is located in any position if it can receive lights from the image generation unit 180. Also, the light sensor 195 can be provided in a position such that it can measure light outputted from the light filter 150, the relay lens 160, the reflection mirror 170, and the projection lens 190.

In the image projection apparatus as shown in FIG. 1, one R-LED 114-R and one B-LED 114-B are both attached to the RB-panel 112-RB, and one G-LED 114-G is attached to the G-panel 112-G. However, this should not be considered as limiting. The number of LEDs attached to a panel is not limited, and it is possible to provide much more number of LEDs.

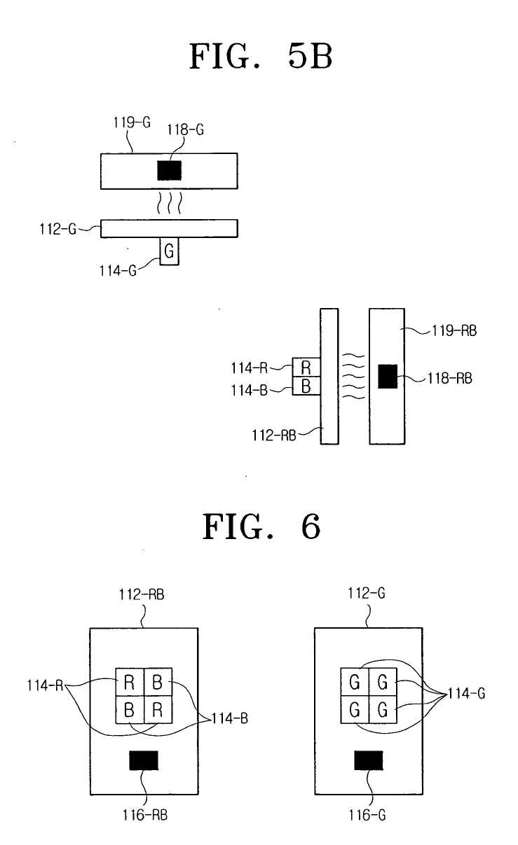

FIG. 6 shows two R-LEDs 114-R and two B-LEDs 114-B attached to a RB-panel 112-RB, and four G-LEDs 114-G attached to a G-panel 112-G. The number (4) of G-LEDs 114-G is two times the number of R-LED 114-R or B-LED 114-B because the light emitted from the G-LED 114-G is weaker than the light emitted from the R-LED 114-R or B-LED 114-B in magnitude. However, if a G-LED 114-G of a greater light magnitude is used, the number of G-LEDs 114-G is the same as that of R-LED 114-R or B-LED 114-B.

In this embodiment, the LEDs are attached to two divided panels. That is, the R-LED 114-R and the B-LED 114-B are attached to the RB-panel 112-RB and the G-LED 114-G is attached to the G-panel 112-G. This is for the convenience of designing the image projection apparatus. It is possible that all of the LEDs are attached to a single panel. That is, the RB-panel 112-RB and the G-panel 112-G are integrated into a single panel, and all of the R-LED 114-R, the B-LED 114-B and the G-LED 114-G are attached to the integrated single panel.

It is possible to realize a projection television using the image projection apparatus according to an embodiment of the present invention. This can be easily implemented by those skilled in the art, and thus, its detailed description is omitted.

As described above, the image projection apparatus according to exemplary embodiments of the present invention is capable of adjusting a white balance in consideration of the temperatures and the light levels of the LEDs. Therefore, even if the temperatures of the LEDs increase due to a prolonged use of the image projection apparatus and thus light levels are deviated from a reference value, a white balance of a projected image is optimally adjusted. As a result, there is no image degradation and an optimal image can be provided to a user.

According to exemplary embodiments of the present invention, the temperatures of the LEDs are firstly measured, and if the temperature exceeds a threshold, the light levels of the LEDs are secondarily measured. Accordingly, the white balance is more appropriately adjusted and thus the image projection apparatus is more effectively driven.

The foregoing embodiment and advantages are merely exemplary and are not to be construed as limiting the present invention. The present teaching can be readily applied to other types of apparatuses. Also, the description of the exemplary embodiments of the present invention is intended to be illustrative, and not to limit the scope of the claims, and many alternatives, modifications, and variations will be apparent to those skilled in the art.

What is claimed is:

1. An image projection apparatus comprising:
a light source unit for sequentially emitting lights generated by a red (R)-light emitting element, a green (G)-light emitting element, and a blue (B)-light emitting element, wherein light levels of the R-light emitting element, the G-light emitting element and the B-light emitting element change depending on changes in temperature;
an image generation unit for generating an image using the lights sequentially emitted from the light source unit and projecting the image;
a driving unit for driving the light source unit and the image generation unit;
a temperature sensor for measuring a temperature of the light source unit;
a light sensor for measuring levels of light generated by the R-light emitting element, the G-light emitting element, and the B-light emitting element; and
a controller for controlling a driving operation of the driving unit based on the levels of light measured by the light sensor if the temperature of the light source unit measured by the temperature sensor exceeds a threshold, and adjusting a white balance of the image projected from the image generation unit.

2. The image projection apparatus as claimed in claim 1, wherein the temperature sensor is provided around at least one of the R-light emitting element, the G-light emitting element, and the B-light emitting element to measure a temperature of the at least one light emitting element.

3. The image projection apparatus as claimed in claim 2, wherein the temperature sensor is provided on a panel to which at least one of the R-light emitting element, the G-light emitting element, and the B-light emitting element is attached.

4. The image projection apparatus as claimed in claim 1, further comprising a heating unit for discharging heat generated from at least one of the R-light emitting element, the G-light emitting element and the B-light emitting element, wherein the temperature sensor is provided on at least one of the heating unit and a surrounding portion of the heating unit to measure the temperature of the light source unit.

5. The image projection apparatus as claimed in claim 1, wherein the light sensor uses light sequentially emitted from the image generation unit and thereby measures light levels of the R-light emitting element, the G-light emitting element, and the B-light emitting element.

6. The image projection apparatus as claimed in claim 1, wherein the driving unit comprises a light source driving unit for generating and supplying a driving pulse for the respective R-light emitting element, G-light emitting element, and B-light emitting element of the light source unit, thereby driving the light source unit, and
the controller determines levels of the driving pulses for the respective R-light emitting element, G-light emitting element, and B-light emitting element based on the level of light measured by the light sensor, and controls the light source driving unit to generate the driving pulses according to the determined pulse levels.

7. The image projection apparatus as claimed in claim 1, wherein the driving unit comprises a light source driving unit for generating and supplying driving pulses for the respective R-light emitting element, G-light emitting elements, and B-light emitting element, thereby driving the light source unit, and
the controller determines pulse-widths and starting times of driving pulses for the respective R-light emitting element, G-light emitting element and B-light emitting element based on the levels of light measured by the light sensor, and controls the light source driving unit to generate the driving pulses according to the determined pulse-widths and starting times.

8. The image projection apparatus as claimed in claim 1, wherein the driving unit comprises an image generation driving unit for generating reflection angle adjustment signals to adjust reflection angles for the lights sequentially entering the image generation unit from the light source unit for each pixel, and supplying the reflection angle adjustment signals to the image generation unit such that the image generation unit generates and projects the image, and
the controller determines levels of the reflection angle adjustment signals based on the levels of lights measured by the light sensor and controls the image generation driving unit to generate reflection angle adjustment signals according to the determined levels of reflection angle adjustment signals.

9. A method of adjusting a white balance of an image projection apparatus comprising a light source unit sequentially emitting lights generated by light emitting elements, wherein light levels of the light emitting elements change depending on changes in temperature, and an image generation unit for generating an image using the lights sequentially emitted from the light source unit and projecting the image, the method comprising:
a) measuring a temperature of the light source unit;
b) measuring levels of lights generated by the light emitting elements if the measured temperature of the light source unit exceeds a threshold,; and
c) controlling a driving operation of one of the light source unit and the image generation unit based on the measured light levels and thereby adjusting a white balance of the image projected from the image generation unit.

10. The method as claimed in claim 9, wherein step a) uses a temperature sensor provided around at least one of the light emitting elements to measure a temperature of the light emitting element located around the temperature sensor.

11. The method as claimed in claim 10, wherein step a) uses the temperature senor provided on a panel to which at least one of the light emitting elements is attached and measures a temperature of the light emitting element located around the temperature sensor.

12. The method as claimed in claim 9, wherein step a) uses a temperature sensor provided on one of a heating unit and a surrounding portion of the heating unit to measure a temperature of the light source unit, the heating unit discharging heats generated from at least one of the light emitting elements.

13. The method as claimed in claim 9, wherein step b) uses lights sequentially emitted from the image generation unit and thereby measures light levels of the light emitting elements.

14. The method as claimed in claim 9, wherein step c) comprises:
determining levels of driving pulses for the respective light emitting elements based on the measure light levels; and
supplying the driving pulses according to the determined pulse levels to the light source unit and driving the light source unit such that a white balance of the image projected from the image generation unit is adjusted.

15. The method as claimed in claim 9, wherein step c) comprises:
determining pulse-widths and starting times of driving pulses for the respective light emitting elements based on the measured light levels; and
supplying the driving pulses according to the determined pulse-widths and starting times to the light source unit and driving the light source unit such that a white balance of the image projected from the image generation unit is adjusted.

16. The method as claimed in claim 9, wherein step c) comprises:
determining levels of reflection angle adjustment signals based on the measured light levels, the reflection angle adjustment signals to adjust reflection angles for the lights sequentially emitted from the light source unit to the image generation unit for each pixel; and
supplying the reflection angle adjustment signals according to the determined signal levels to the image generation unit in order for the image generation unit to generate and project the image, such that a white balance of the image projected from the image generation unit is adjusted.

17. An image projection apparatus comprising:
a light source unit for sequentially emitting lights generated by light emitting elements, wherein light levels of the light emitting elements change depending on changes in temperature;
an image generation unit for generating an image using the lights sequentially emitted from the light source unit and projecting the image;
a driving unit for driving the light source unit and the image generation unit;
a temperature sensor for measuring a temperature of the light source unit;
a light sensor for measuring levels of light generated by the light emitting elements; and
a controller for controlling a driving operation of the driving unit based on the levels of light measured by the light sensor if the temperature of the light source unit measured by the temperature sensor exceeds a threshold, and adjusting a white balance of the image projected from the image generation unit.

18. The image projection apparatus as claimed in claim 17, wherein the light emitting elements comprise a light emitting diode (LED)
